(19) United States
(12) Patent Application Publication
(10) Pub. No.: US 2006/0001375 A1
(43) Pub. Date: Jan. 5, 2006

(54) Plasma display panel (PDP)

(76) Inventors: Min Hur, Suwon-si (KR); Hoon-Young Choi, Suwon-si (KR)

Correspondence Address: Robert E. Bushnell, Suite 300, 1522 K Street, N.W., Washington, DC, 20005, US

(21) Appl. No.: 11/166,376

(22) Filed: Jun. 27, 2005

(30) Foreign Application Priority Data
Jun. 30, 2004 (KR) 10-2004-0050686

(51) Int. Cl. H01J 17/49

(52) U.S. Cl. 313/582

(57) ABSTRACT

A Plasma Display Panel (PDP) having an electrode structure capable of implementing a high-density and high-luminance display includes: a first substrate and a second substrate facing each other and adapted to define a space partitioned into a plurality of discharge cells; address electrodes arranged between the first substrate and the second substrate to extend parallel to each other; phosphor layers arranged in the plurality of discharge cells; and first and second electrodes arranged to extend in a direction intersecting the address electrodes between the first and second substrates, and alternately arranged to correspond to boundaries between adjacent discharge cells along a direction in which the address electrodes extend; and third electrodes arranged between the first and second electrodes to pass through internal spaces of the discharge cells; at least one of the first, second, and third electrodes has protrusions protruding in the internal spaces of the discharge cells.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 30 Jun. 2004 and there duly assigned Serial No. 10-2004-0050686.

### BACKGROUND OF THE INVENTION

1. Field of the Invention

The present invention relates to a Plasma Display Panel (PDP), and more particularly, to a PDP having an electrode structure capable of implementing a high-density high-luminance display.

2. Description of the Related Art

A Plasma Display Panel (PDP) is a display apparatus using a plasma discharge. Vacuum UltraViolet (VUV) light emitted by the plasma discharge excites phosphor layers, and in turn, the phosphor layers emit visible light. The visible light is used to display images. Recently, PDPs have been implemented as thin wide screen apparatus having a screen size of 60 inches or more and a thickness of 10 cm or less. In addition, since a PDP is a spontaneous light emitting apparatus, like a CRT, a PDP has excellent color reproducibility. In addition, a PDP has no image distortion associated with its viewing angle. Moreover, a PDP can be manufactured by a simpler method than an LCD, so that a PDP can be produced with a low production cost and a high productivity. Therefore, the PDP is expected to be a next-generation display apparatus for industry and home TVs.

Since the 1970s, a variety of PDP structures have been developed. A three-electrode surface-discharge PDP has been widely used. In the three-electrode surface-discharge PDP, two electrodes including scan and sustain electrodes are disposed on one substrate, and one address electrode is disposed on another substrate in a direction intersecting the scan and sustain electrodes. The two substrates are separated from each other to form a discharge space. The discharge space is filled with a discharge gas. In the three-electrode surface-discharge PDP, the presence of a discharge is determined by an address discharge. Specifically, the address discharge is generated as a face discharge between the scan electrode controlled separately and the address electrode opposite to the scan electrode, and a sustain discharge related to brightness is generated as a surface discharge between the scan and sustain electrodes disposed on the same substrate.

A PDP uses a glow discharge to generate visible light. Several steps occur to generate visible light from the glow discharge. First, the glow discharge emits electrons, and the electrons collide with a discharge gas, to excite the discharge gas. Next, UltraViolet (UV) light is emitted from the excited discharge gas. The UV light impinges on phosphor layers in discharge cells, to excite the phosphor layers. Then, the visible light is emitted from the excited phosphor layers. Lastly, the visible light passes through a transparent substrate and is perceived by human eyes. In this series of steps, a relatively large amount of input energy is lost.

The glow discharge is generated by supplying a voltage above a discharge firing voltage between two electrodes at a low pressure (<I atm). The discharge firing voltage is a function of the type of discharge gas, an ambient pressure, and a distance between electrodes. For an AC glow discharge, in addition to the three variables, the discharge firing voltage depends on the capacitance of a dielectric interposed between the two electrodes and a frequency of the supplied voltage. The capacitance is a function of a dielectric constant of the dielectric material, an area of the electrode, and a thickness of the dielectric material.

A high voltage needs to be supplied in order to fire the glow discharge. Once the discharge has occurred, the voltage distribution between anode and cathode has a distorted shape due to a difference of space charges generated at anode and cathode sheaths, that is, regions near the anode and cathode. Most of the voltage is at the anode and cathode sheaths. In addition, a relatively small amount of the voltage is at a positive column region. In particular, it is known that, in the glow discharge of the PDP, the voltage at the cathode sheath is far higher than the voltage at the anode sheath.

The visible light emitted from the phosphor layers is caused by the impact of the VUV light on the phosphor layers. The VUV light is generated when an energy state of Xe in the discharge gas changes from its excited state to its ground state. The excited state of Xe is caused by the collision of the excited electrons with the ground-state Xe. Therefore, in order to increase a luminescence efficiency, that is, a ratio of a visible-light-generating energy to the input energy, it is necessary to increase an electron heating efficiency, that is, a ratio of electron-heating energy to the input energy.

The electron heating efficiency of the positive column region is higher than that of the cathode sheath. Therefore, the luminescence efficiency of PDP can be increased by widening the positive column region. In addition, since the sheath has a constant thickness at a given pressure, it is necessary to lengthen a distance of discharge in order to increase the luminescence efficiency

In a three-electrode PDP, the discharge is initiated at a central region of the discharge cell, that is, the region closest to both of the two electrodes. This is because the discharge firing voltage is low at the central region of the discharge cell. The discharge firing voltage is a function of a product of a pressure and a distance between electrodes. In addition, an operation range of the PDP is to the right of a minimum value in the Paschen curve. Once the discharge occurs, space charges are generated, so that the discharge can be sustained at a voltage less than the discharge firing voltage. In addition, the voltage between the two electrodes gradually decreases with time. After the discharge occurs, ions and electrons are accumulated on the central region of the discharge cell, so that the electric field is weakened. Finally, the discharge in the region disappears.

The anode and cathode spots move with time toward regions where there is no surface charge, that is, the edges of the two electrodes. Since the voltage between the two electrodes decreases with time, a strong discharge is generated at the central region of discharge cell (with a low luminescence efficiency), and a weak discharge is generated at the edges of the discharge cell (with a high luminescence efficiency). Therefore, in such a three-electrode PDP, the electron heating efficiency is lowered, so that the luminescence efficiency is lowered.

In order to overcome the shortcomings of such three-electrode PDPs, an approach for lengthening the distance between display electrodes has been considered. The approach has a problem of increasing the discharge firing voltage.

### SUMMARY OF THE INVENTION

An object of the present invention is to provide a Plasma Display Panel (PDP) capable of increasing a luminescence efficiency as well as decreasing a discharge firing voltage and easily generating an address discharge by adding additional electrodes disposed between electrodes involved in a sustain discharge to generate a sustain discharge as a face discharge

In order to achieve the object, according to an aspect of the present invention, a Plasma Display Panel (PDP) is provided comprising: a first substrate and a second substrate facing each other and adapted to define a space partitioned into a plurality of discharge cells; address electrodes arranged between the first substrate and the second substrate to extend parallel to each other; phosphor layers arranged in the plurality of discharge cells; and first and second electrodes arranged to extend in a direction intersecting the address electrodes between the first and second substrates, and alternately arranged to correspond to boundaries between adjacent discharge cells along a direction in which the address electrodes extend; and third electrodes arranged between the first and second electrodes to pass through internal spaces of the discharge cells; wherein at least one of the first, second, and third electrodes has protrusions protruding in the internal spaces of the discharge cells.

The PDP preferably further comprises barrier ribs adapted to partition the space between the first and second substrates into a plurality of the discharge cells; the barrier ribs including: first barrier rib elements arranged in a direction parallel to the address electrodes; and second barrier rib elements arranged in a direction intersecting the address electrodes.

The barrier ribs preferably further comprise auxiliary barrier rib elements arranged between adjacent second barrier rib elements in a direction parallel to the second barrier rib elements.

The phosphor layers are preferably arranged on side walls of the auxiliary barrier rib elements.

Heights of transverse cross-sections of the auxiliary barrier rib elements are preferably smaller than heights of transverse cross-sections of the second barrier rib elements.

The first and second electrodes preferably include protrusions protruding toward the third electrodes and arranged on side walls of the first and second electrodes at central positions between the first and second substrates.

The first and second electrodes preferably have protrusions protruding toward the third electrodes and arranged on side walls of the first and second electrodes closer to one of the first and second substrates.

The PDP preferably further comprises a dielectric layer adapted to surround the first and second electrodes and their corresponding protrusions.

The PDP further preferably comprises a dielectric layer adapted to surround the first and second electrodes and their corresponding protrusions.

Transverse cross-sections of the first and second electrodes and the second barrier rib elements corresponding to the first and second electrodes respectively preferably have the same central lines of symmetry.

Heights of the transverse cross-sections of the first and second electrodes in a direction perpendicular to the substrates are preferably greater than widths thereof in a direction parallel to the substrates.

The PDP preferably further comprises a protective layer arranged on at least a side surface of the first and second electrodes exposed to the internal spaces of the discharge cells.

The protective layer is preferably non-transparent to visible light.

The PDP preferably further comprises a dielectric layer surrounding the third electrodes.

Transverse cross-sections of the third electrodes and their corresponding auxiliary barrier rib elements preferably have the same central lines of symmetry.

The third electrodes are preferably attached to the auxiliary barrier rib elements.

The third electrodes preferably comprise floating electrodes arranged over the auxiliary barrier rib elements.

Heights of transverse cross-sections of the third electrodes in a direction perpendicular to the substrates are preferably smaller than heights of transverse cross-sections of the first and second electrodes.

The third electrodes are preferably arranged corresponding to the protrusions of the first and second electrodes in a direction perpendicular to the substrates.

The third electrodes are preferably arranged corresponding to the protrusions on side walls of the first and second electrodes at central positions between the first and second substrates.

The third electrodes are preferably arranged corresponding to the protrusions on side walls of the first and second electrodes closer to one of the first and second substrates.

The PDP preferably further comprises a protective layer arranged on at least a side surface of the third electrodes exposed to the internal spaces of the discharge cells.

The protective layer is preferably non-transparent to visible light.

The barrier ribs preferably further comprise: third barrier rib elements arranged corresponding to the first barrier rib elements to protrude toward the first substrate; and fourth barrier rib elements arranged corresponding to the second barrier rib elements to protrude toward the first substrate; the third and fourth barrier rib elements are preferably arranged on the second substrate.

The first and second electrodes are preferably arranged between the corresponding second and fourth barrier rib elements facing each other, and the third electrodes are preferably arranged between the auxiliary barrier rib elements and the third barrier rib elements intersecting each other.

The phosphor layers are preferably arranged on regions of the second substrate partitioned by the third and fourth barrier rib elements.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph of a distribution of voltage supplied between anode and cathode in a glow discharge;

FIG. 2 is a partially exploded perspective view of a PDP according to a first embodiment of the present invention;

FIG. 3 is a schematic plan view of an electrode and discharge cell structure of the PDP according to the first embodiment of the present invention;

FIG. 4 is a partial cross-sectional view taken along line IV-IV of FIG. 2 of the assembled PDP;

FIG. 5 is a partial plan view of a PDP according to a second embodiment of the present invention; and

FIG. 6 is a partial plan view of a PDP according to a third embodiment of the present invention; and

### DETAILED DESCRIPTION OF THE INVENTION

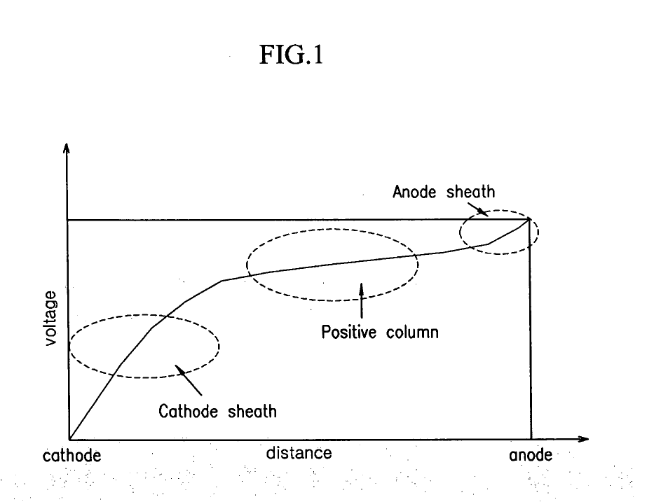

FIG. 1 is a graph of a distribution of voltage supplied between anode and cathode in a glow discharge.

A high voltage needs to be supplied in order to fire the glow discharge. Once the discharge has occurred, the voltage distribution between anode and cathode has a distorted shape, as shown in FIG. 1, due to a difference of space charges generated at anode and cathode sheaths, that is, regions near the anode and cathode. As shown in FIG. 1, most of the voltage is at the anode and cathode sheaths. In addition, a relatively small amount of the voltage is at a positive column region. In particular, it is known that, in the glow discharge of the PDP, the voltage at the cathode sheath is far higher than the voltage at the anode sheath.

Embodiments of the present invention are described below in detail with reference to the accompanying drawings. The present invention can, however, be embodied in many different forms and should not be construed as being limited to the embodiments set forth herein; rather, these embodiments are provided so that this disclosure will be thorough and complete, and will fully convey the concepts of the present invention to those skilled in the art. Like reference numerals in the drawings denote like elements, and thus repeated descriptions thereof have been omitted.

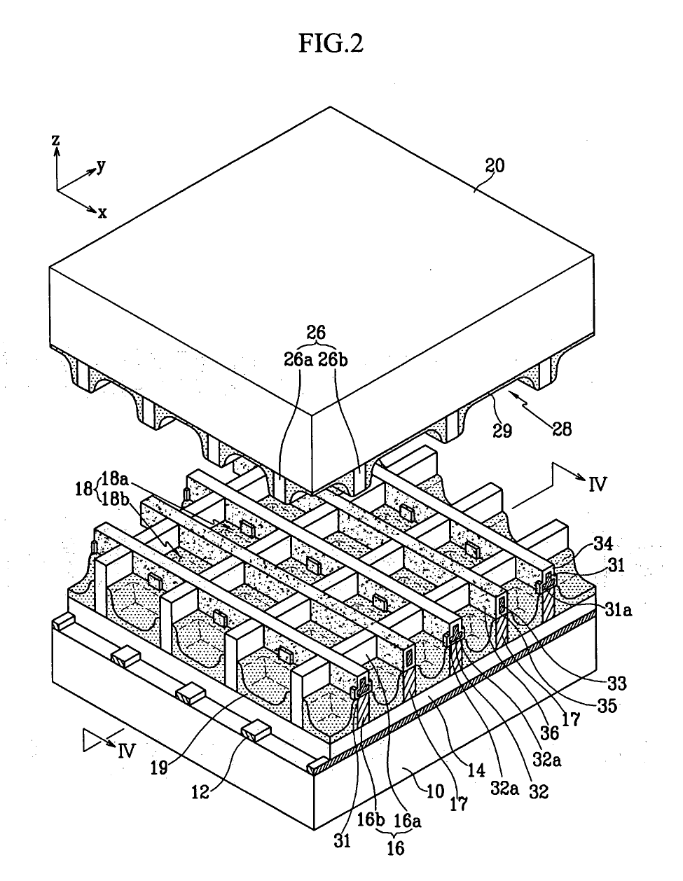

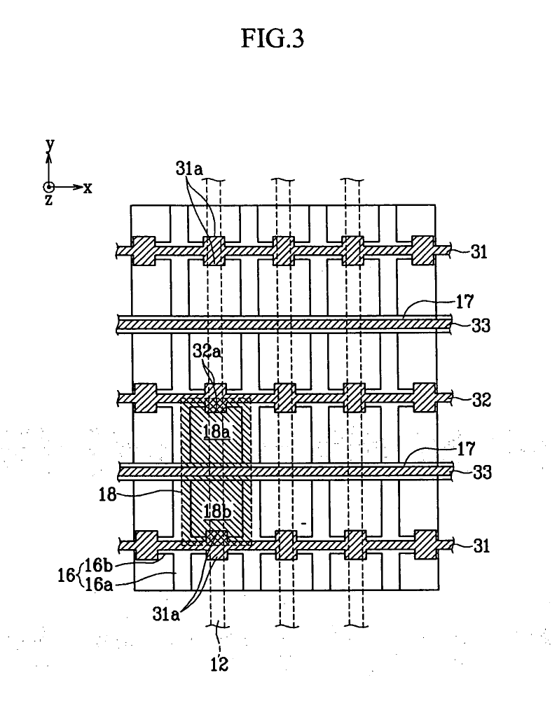

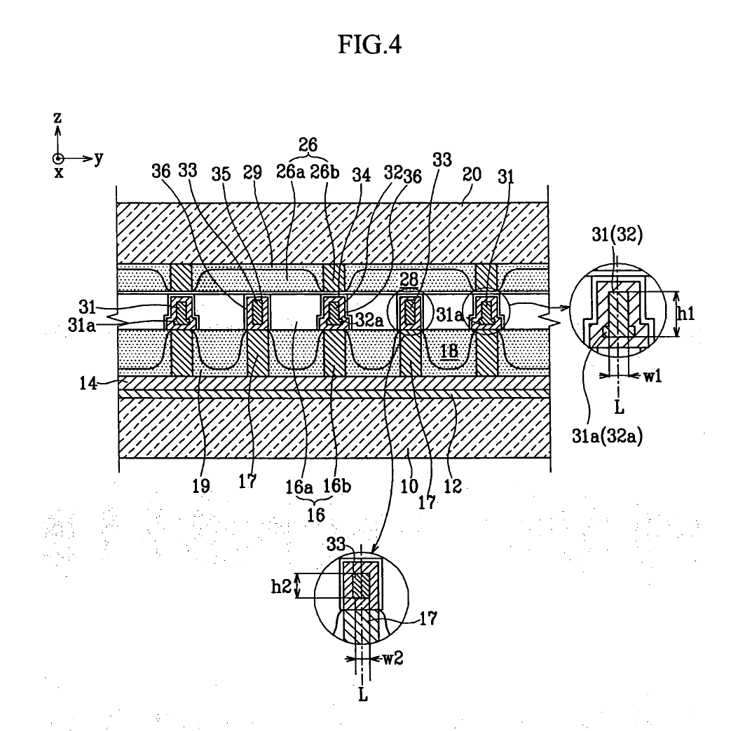

FIG. 2 is a partially exploded perspective view of a PDP according to a first embodiment of the present invention. FIG. 3 is a schematic plan view of an electrode and discharge cell structure of the PDP according to the first embodiment of the present invention. FIG. 4 is a partially cross-sectional view taken along line IV-IV of FIG. 2 of the assembled PDP.

The PDP according to the first embodiment includes a first substrate 10 (hereinafter, referred to as a rear substrate) and a second substrate 20 (hereinafter, referred to as a front substrate). The rear and front substrates 10 and 20 face each other with a predetermined interval to provide a discharge space. The discharge space is partitioned by barrier ribs 16 and 26 to define a plurality of discharge cells 18. Phosphor layers are disposed to coat sidewalls of the barrier ribs 16 and bottom surfaces of the discharge cells 18. The phosphor layers 19 absorb VUV light and emit visible light. The discharge cells 18 of the discharge space are filled with a discharge gas. For example, the discharge gas is a mixture of Xe and Ne.

Address electrodes 12 are disposed parallel to each other on an inner surface of the rear substrate 10 in a direction (the Y direction in the figure). A dielectric layer 14 is disposed on the inner surface of the rear substrate 10 to cover the address electrodes 12. The adjacent address electrodes 12 are separated from each other by a predetermined distance, that is, an x-directional distance between the adjacent discharge cells 18.

The barrier ribs 16 and 26 includes rear-substrate barrier ribs 16 protruding from the rear substrate 10 toward the front substrate 20 and front-substrate barrier ribs 26 protruding from the front substrate 20 toward the rear substrate 10.

The rear-substrate barrier ribs 16 are disposed on the dielectric layer 14 which is disposed on the rear substrate 10. The rear-substrate barrier ribs 16 comprise first barrier rib elements 16a extending in a direction parallel to the address electrodes 12 and second barrier rib elements 16b extending in a direction intersecting the first barrier rib elements 16a to define the discharge cells 18 as individual discharge spaces. The front-substrate barrier ribs 26 comprise third barrier rib elements 26a corresponding to the first barrier rib elements 16a and fourth barrier rib elements 26b corresponding to the second barrier rib elements 16b. The third and fourth barrier rib elements 26a and 26b intersect each other to define regions 28 corresponding to the discharge cells 18.

In addition, auxiliary barrier rib elements 17 are further disposed in the direction parallel to the second barrier rib elements 16b between adjacent second barrier rib elements 16b. Namely, the auxiliary barrier rib elements 17 and the second barrier rib elements 16b are alternately disposed along the longitudinal direction (the Y direction in the figure) of the address electrodes 12. Therefore, the auxiliary barrier rib elements 17 are disposed on the rear substrate 10 to partition the discharge cell 18 into two regions 18a and 18b.

First and second electrodes 31 and 32 are disposed to extend in a direction (the X direction in the figure) parallel to the second barrier rib elements 16b between the rear and front substrate 10 and 20, corresponding to the second barrier rib elements 16b. More specifically, the first and second electrodes 31 and 32 are alternately disposed on top surfaces of the second barrier rib elements 16b to partition the discharge cells 18 in the longitudinal direction (Y direction in the figure) of the address electrodes 12.

In addition, third electrodes 33 are disposed between the adjacent first and second electrodes 31 and 32. Namely, the third electrodes are disposed to extend in a direction (the X direction in the figure) parallel to the auxiliary barrier rib elements 17, corresponding to the auxiliary barrier rib elements 17 disposed between the second barrier rib elements 16b. The third electrodes 33 are disposed to pass through the first barrier rib elements 16a across internal spaces of the discharge cells 18.

The third electrodes 33 together with the first or second electrodes 31 or 32 are involved with discharges during a reset period. The third electrodes 33 together with the address electrodes 12 are involved with discharges during an address period to select to-be-displayed discharge cells 18. The pairs of first electrodes 31 together with the second electrodes 32 are involved with discharges during sustain periods to display an image on a screen. These electrodes can have different functions according to the supplied signal voltages. The present invention is not limited thereto.

Referring to FIG. 3, each of the discharge cells 18 is divided into two regions 18a and 18b by the auxiliary barrier rib element 17 and the third electrode 33. In a sustain period, in each of the regions 18a and 18b, sustain discharges occur between the first and second electrodes 31 and 32. Since the third electrodes 33 disposed across the discharge cells 18 have a function of supporting the generation of sustain discharges between the first and second electrodes 31 and 32 disposed on both sides of the third electrodes 33, it is possible to decrease 11a discharge firing voltage.

In addition, the first and second electrodes 31 and 32 have protrusions 31a and 32a respectively protruding toward the second and first electrodes 32 and 31 in the discharge cells 18. Alternatively, protrusions 31a can be provided for only the first electrodes 31. Also, protrusions 32a can be provided for only the second electrodes 32. The discharge gap between the first and second electrodes 31 and 32 can be further reduced due to the protrusions 31a and 32a, so that it is possible to lower the discharge firing voltage. In addition, the third electrodes 33 lengthen the discharge path after the discharge occurs, so that it is possible to further increase the luminescence efficiency. Although the protrusions 31a and 31b are provided for only the first and second electrodes 31 and 32 in the embodiment, the present invention is not limited thereto. The protrusions can be provided for the third electrodes 33.

Referring to FIG. 4, in this embodiment, transverse cross-sections of the first and second electrodes 31 and 32 and the corresponding second barrier ribs 16b have substantially the same central lines of symmetry L. Therefore, each of the first and second electrodes 31 and 32 can be involved with the discharges of the discharge cells 18 which are adjacent to each other in the longitudinal direction (the Y direction in the figure) of the address electrodes 12. In addition, transverse cross-sections of the third electrodes 33 and the corresponding auxiliary barrier rib elements 17 have substantially the same central lines of symmetry L. Therefore, each of the third electrodes 33 can be involved with the discharges of both regions 18a and 18b of the discharge cell 18.

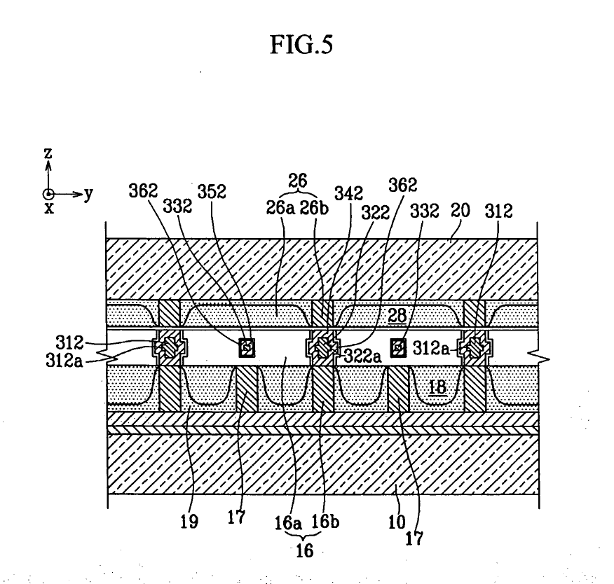

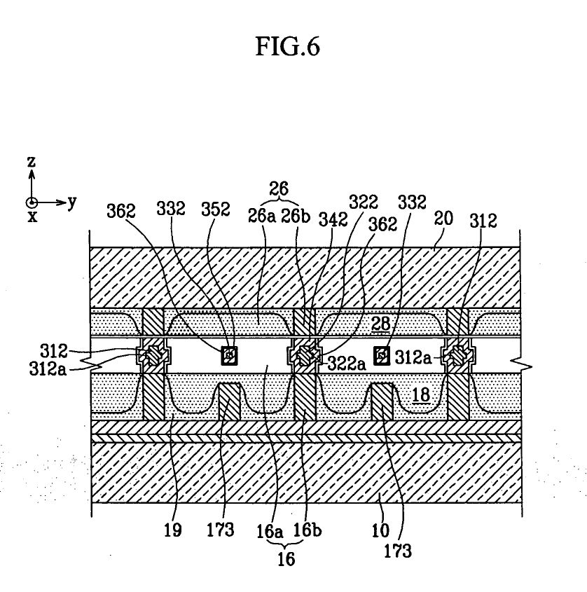

In this embodiment, heights h1 of the transverse cross-sections of the first and second electrodes 31 and 32 in a direction perpendicular to the substrates 10 and 20 are larger than widths w1 thereof in a direction parallel to the substrates 10 and 20. Although the third electrodes 33 have a shape corresponding to the first and second electrodes 31 and 32 (see FIG. 4), heights h2 of the third electrodes 33 in a direction perpendicular the substrates 10 and 20 are approximately equal to the widths w2 thereof in a direction parallel to the substrates 10 and 20 (see FIGS. 5 and 6). The widths and heights w2 and h2 of the transverse cross-sections of the third electrodes 33 are preferably smaller than the widths and heights w1 and h2 of the transverse cross-sections of the first and second electrodes 31 and 32. Namely, the areas of the transverse cross-sections of the third electrodes 33 are smaller than those of the first and second electrodes 31 and 32. The third electrodes 33 can be formed corresponding to various heights h1 of the first and second electrodes 31 and 32 in a direction (the Z direction in the figure) perpendicular to the substrates 10 and 20. In order to obtain a high luminescence efficiency by easily generating a face discharge between the first and second electrodes 31 and 32, the heights h2 of the third electrodes 33 are preferably smaller than the heights h1 of the first and second electrodes 31 and 32 in a direction perpendicular to the substrates 10 and 20. Therefore, obstructions to the facing discharge between the first and second electrodes 31 and 32 can be minimized, so that it is possible to prevent an address discharge from occurring on surfaces facing the address electrodes 12 and to generate the address discharge on the surfaces facing the first and second electrodes 31 and 32.

The first and second electrodes 31 and 32 and the corresponding protrusions 31a and 32a are surrounded with dielectric layers 34. In addition, the third electrodes 33 are also surrounded with the dielectric layers 35. The first, second, and third electrodes 31, 32, and 33 can be formed by using a Thick Film Ceramic Sheet (TFCS) method. More specifically, electrode portions including the first, second, and third electrodes 31, 32, and 33 can be individually formed, and then, assembled into the rear substrate 10 where the barrier ribs are formed. The electrodes are coated with a ceramic material.

The protrusions 31a and 32a can be disposed at various positions between the rear and front substrates 10 and 20 along the direction perpendicular to the rear and front substrates 10 and 20. In this embodiment, the protrusions 31a and 32a are disposed closer to the rear substrate 10. Alternatively, the protrusions 31a and 32a can be disposed closer to the front substrate 20 or at the central position between the rear and front substrates 10 and 20.

An MgO protective layer 36 can be disposed on the dielectric layers 34 and 35. Particularly, the MgO protective layer 36 can be formed in portions of the discharge cell 18 exposed to the plasma discharge therein. In this embodiment, since the first, second, and third electrodes 31, 32, and 33 are not disposed on the front substrate 20, the protective layer 36 coated on the dielectric layers 34 and 35 covering the first, second, and third electrodes 31, 32, and 33 can be made of a visible-light-non-transparent MgO. The visible-light-non-transparent MgO has a higher secondary electron emission coefficient than a visible-light-transparent MgO has. Therefore, it is possible to further reduce the discharge firing voltage.

In this embodiment, since the third electrodes 33 are disposed corresponding to the auxiliary barrier rib elements 17, it is possible to support the third electrodes in the discharge cells 18 with a stable structure and to prevent the address discharges from occurring between the address electrodes 12 and the bottom surface of the third electrodes 33. Therefore, the address discharge can be generated between the address electrodes 12 and the side walls of the third electrodes 33.

The first and second electrodes 31 and 32 provided with the dielectric layer 34 and the MgO protective layer 36 are disposed between the second and fourth barrier rib elements 16b and 26b in the direction parallel to second and fourth barrier rib element 16b and 26b. On the other hand, the third electrodes 33 provided with the dielectric layer 35 and the MgO protective layer 36 are disposed between the auxiliary barrier rib elements 17 and third barrier rib elements 26a in the direction parallel to the auxiliary barrier rib elements 17 and in the direction intersecting the third barrier rib elements 26a.

In addition, in order to dispose the third electrodes 33 and auxiliary barrier rib elements 17, grooves can be formed on some portions of the first barrier rib elements 16a, and the third electrodes 33 provided with the dielectric layer 35 and the MgO protective layer 36 can be inserted into the grooves on the auxiliary barrier rib elements 17. The distance between the third electrodes 33 and the rear substrate 10 can be equal to the distances between the first and second electrodes 31 and 32 and the rear substrate 10. In addition, a top surface of the dielectric layer 35 surrounding the third electrodes 33 can match with a top surface of the first barrier rib element 16a. In addition, the third electrodes 33 can be disposed to pass through the first barrier rib elements 16a.

The first and second electrodes 31 and 32 are preferably made of a highly conductive metallic material.

On the other hand, phosphor layers 29 are formed on regions of the front substrate 20 partitioned by the third and fourth barrier rib elements 26a and 26b. After a dielectric layer is coated on the front substrate 20 and the front-substrate barrier ribs 26 are disposed on the dielectric layer, the phosphor layers 29 are coated on the remaining dialectric layer. Alternatively, the dialectric layer can be un-coated. After the front-substrate barrier ribs 26 have been disposed on the front substrate 20, the phosphor layers 29 can be coated on the front substrate 20. In addition, after the front substrate 20 has been etched according to shapes of the discharge cells 18, the phosphor layers 29 can be coated thereon. The front-substrate barrier ribs 26 are made of the same material as the front substrate 20.

The phosphor layers 29 formed on the front substrate 20 are used to absorb VUV light (emitted from the plasma discharge in the direction from the discharge cells 18 toward the front substrate 20) and emit visible light. The phosphor layers 29 need to pass the visible light. Therefore, a thickness of the phosphor layers 29 disposed on the front substrate 20 can be smaller than a thickness of the phosphor layers 19 disposed on the rear substrate 10.

According to this construction, it is possible to minimize the loss of VUV light and improve the luminescence efficiency.

In addition, in this embodiment, since the auxiliary barrier rib elements 17 are further disposed on the rear substrate 10 and the phosphor layers 19 are further disposed on the side surfaces of the auxiliary barrier rib elements 17, it is possible to increase areas of the phosphor layers 19, on which the VUV light impinges. Therefore, it is possible to increase visible light emitted from the PDP.

In this embodiment, as an example, the heights of the third electrodes 33 in the direction (the Z direction in the figure) perpendicular to the substrates 10 and 20 are designed to be equal to the heights of the first and second electrodes 31 and 32.

FIGS. 5 and 6 are partial plan views of PDPs according to second and third embodiments of the present invention.

In comparison to the first embodiment, in the second and third embodiments, the protrusions 312a and 322a are disposed at the central positions of side walls of the first and second electrodes 312 and 322 between the rear and front substrates 10 and 20. The third electrodes 332 are disposed at positions corresponding to the positions of the protrusions 312a and 322a in the direction perpendicular to the substrates 10 and 20.

In FIG. 5, the heights of the auxiliary barrier rib elements 17 are equal to those of the second barrier rib elements 16b. In FIG. 6, the heights of the auxiliary barrier rib elements 173 are smaller than those of the second barrier rib elements 16b.

In the second and third embodiments of FIGS. 5 and 6, since a dielectric layer 352 and an MgO protective layer 362 are disposed on the top surfaces of the third electrodes 332 or the top and bottom surfaces thereof, a larger amount of wall charges are accumulated during the address discharge, so that it is possible to further decrease the discharge firing voltage. In addition, since the heights of the auxiliary barrier rib elements 173 in the third embodiment of FIG. 6 are smaller than those in the second embodiment of FIG. 5, the obstruction to the face discharge between the first and second electrodes 312 and 322 can be minimized, so that it is possible to more easily generate the face discharge.

According to a PDP of the present invention, electrodes involved with a sustain discharge are disposed on both sides of discharge cells to face each other, and electrodes involved with reset and address discharges are disposed between the electrodes involved with the sustain discharges, so that it is possible to generate the sustain discharge as a face discharge. In addition, gaps between the electrodes for causing the discharge can be shortened, so that it is possible to decrease a discharge firing voltage. In addition, after the discharge occurs, gaps between the electrodes involved with the sustain discharge can be lengthened, so that it is possible to increase a luminescence efficiency.

According to the PDP of the present invention, heights of the electrodes involved with the reset and address discharges are smaller than those of the electrode involved with the sustain discharge, and top and bottom surfaces and side walls of the electrodes involved with the reset X and address discharges are surrounded with a dielectric layer and an MgO protective layer, so that a larger amount of wall charges can be accumulated. As a result, it is possible to more easily cause the discharge.

According to the PDP of the present invention, protrusions are disposed on the electrodes involved with the sustain discharge or the electrodes involved with the reset and address discharges, so that the gaps between the electrodes can be further shortened. As a result, it is possible to further decrease the discharge firing voltage.

Although the exemplary embodiments and the modified examples of the present invention have been described, the present invention is not limited to the embodiments and examples, but can be modified in various forms without departing from the scope of the appended claims, the detailed description, and the accompanying drawings of the present invention.

What is claimed is:

1. A Plasma Display Panel (PDP), comprising:
a first substrate and a second substrate facing each other and adapted to define a space partitioned into a plurality of discharge cells;
address electrodes arranged between the first substrate and the second substrate to extend parallel to each other;
phosphor layers arranged in the plurality of discharge cells; and
first and second electrodes arranged to extend in a direction intersecting the address electrodes between the first and second substrates, and alternately arranged to correspond to boundaries between adjacent discharge cells along a direction in which the address electrodes extend; and
third electrodes arranged between the first and second electrodes to pass through internal spaces of the discharge cells;
wherein at least one of the first, second, and third electrodes has protrusions protruding in the internal spaces of the discharge cells.

2. The PDP of claim 1, further comprising barrier ribs adapted to partition the space between the first and second substrates into a plurality of the discharge cells; the barrier ribs including:
first barrier rib elements arranged in a direction parallel to the address electrodes; and second barrier rib elements arranged in a direction intersecting the address electrodes.

3. The PDP of claim 2, wherein the barrier ribs further comprise auxiliary barrier rib elements arranged between adjacent second barrier rib elements in a direction parallel to the second barrier rib elements.

4. The PDP of claim 3, wherein the phosphor layers are arranged on side walls of the auxiliary barrier rib elements.

5. The PDP of claim 3, wherein heights of transverse cross-sections of the auxiliary barrier rib elements are smaller than heights of transverse cross-sections of the second barrier rib elements.

6. The PDP of claim 1, wherein the first and second electrodes include protrusions protruding toward the third electrodes and arranged on side walls of the first and second electrodes at central positions between the first and second substrates.

7. The PDP of claim 1, wherein the first and second electrodes have protrusions protruding toward the third electrodes and arranged on side walls of the first and second electrodes closer to one of the first and second substrates.

8. The PDP of claim 6, further comprising a dielectric layer adapted to surround the first and second electrodes and their corresponding protrusions.

9. The PDP of claim 7, further comprising a dielectric layer adapted to surround the first and second electrodes and their corresponding protrusions.

10. The PDP of claim 2, wherein transverse cross-sections of the first and second electrodes and the second barrier rib elements corresponding to the first and second electrodes respectively have the same central lines of symmetry.

11. The PDP of claim 1, wherein heights of the transverse cross-sections of the first and second electrodes in a direction perpendicular to the substrates are greater than widths thereof in a direction parallel to the substrates.

12. The PDP of claim 1, further comprising a protective layer arranged on at least a side surface of the first and second electrodes exposed to the internal spaces of the discharge cells.

13. The PDP of claim 12, wherein the protective layer is non-transparent to visible light.

14. The PDP of claim 1, further comprising a dielectric layer surrounding the third electrodes.

15. The PDP of claim 3, wherein transverse cross-sections of the third electrodes and their corresponding auxiliary barrier rib elements have the same central lines of symmetry.

16. The PDP of claim 3, wherein the third electrodes are attached to the auxiliary barrier rib elements.

17. The PDP of claim 3, wherein the third electrodes comprise floating electrodes arranged over the auxiliary barrier rib elements.

18. The PDP of claim 1, wherein heights of transverse cross-sections of the third electrodes in a direction perpendicular to the substrates are smaller than heights of transverse cross-sections of the first and second electrodes.

19. The PDP of claim 18, wherein the third electrodes are arranged corresponding to the protrusions of the first and second electrodes in a direction perpendicular to the substrates.

20. The PDP of claim 18, wherein the third electrodes are arranged corresponding to the protrusions on side walls of the first and second electrodes at central positions between the first and second substrates.

21. The PDP of claim 18, wherein the third electrodes are arranged corresponding to the protrusions on side walls of the first and second electrodes closer to one of the first and second substrates.

22. The PDP of claim 1, further comprising a protective layer arranged on at least a side surface of the third electrodes exposed to the internal spaces of the discharge cells.

23. The PDP of claim 22, wherein the protective layer is non-transparent to visible light

24. The PDP of claim 2, wherein the barrier ribs further comprise:
third barrier rib elements arranged corresponding to the first barrier rib elements to protrude toward the first substrate; and
fourth barrier rib elements arranged corresponding to the second barrier rib elements to protrude toward the first substrate;
wherein the third and fourth barrier rib elements are arranged on the second substrate.

25. The PDP of claim 24, wherein the first and second electrodes are arranged between the corresponding second and fourth barrier rib elements facing each other, and wherein the third electrodes are arranged between the auxiliary barrier rib elements and the third barrier rib elements intersecting each other.

26. The PDP of claim 24, wherein the phosphor layers are arranged on regions of the second substrate partitioned by the third and fourth barrier rib elements.
